(19) United States
(12) Patent Application Publication
(10) Pub. No.: US 2017/0287094 A1
(43) Pub. Date: Oct. 5, 2017

(54) Placement Referral Intelligent Matching Engine and Web Portal

(71) Applicant: Spirit, Inc., Henderson, NV (US)

(72) Inventors: William Monroe Nidiffer, Henderson, NV (US); Eric Monroe Nidiffer, Henderson, NV (US)

(21) Appl. No.: 15/472,890

(22) Filed: Mar. 29, 2017

Related U.S. Application Data
(60) Provisional application No. 62/314,929, filed on Mar. 29, 2016.

(51) Int. Cl. G06Q 50/26; G06Q 10/10; G06Q 30/00; H04L 29/08

(52) U.S. Cl. CPC G06Q 50/26; H04L 67/02; H04L 67/306; G06Q 10/1093; G06Q 30/018

(57) ABSTRACT

A computer-implemented system includes a cloud-based encrypted database; a web portal for a placement entity configured to enable creation of a profile containing data for each youth in a foster care program, and storing the youth profile data and role-based data access permissions in the encrypted database; a web portal for a recruitment entity to identify, communicate with, and start the licensing process for a prospective foster parent family; a web portal for a licensing entity configured to enable creation of a profile containing data for each foster family, and storing the foster family profile data and role-based data access permissions in the encrypted database; a matching engine configured to access the cloud-based encrypted database to search the youth and foster family profiles, the matching engine further configured to identify best matches between foster families and youths, and generating a referral match; and a web portal for each foster family configured to enable updating of foster family profile data, receiving new referral matches, and communicating with the licensing entity via messages.

### RELATED APPLICATION

The present application claims the benefit of U.S. Provisional Application 62/314,929 filed on Mar. 29, 2016, and further incorporates by reference U.S. application Ser. No. 13/289,269 filed on Nov. 4, 2011, which claims benefit of U.S. Provisional Application 61/410,067 filed on Nov. 4, 2010.

### FIELD

The present disclosure relates to the field of computer systems and methods for youth services, and in particular a cloud-based placement referral intelligent matching engine (PRIME) to match foster families to foster youths and web portal.

### BACKGROUND

Foster care is intended to serve as a temporary haven for abused or neglected children who cannot safely remain with their families. However, for some children, the journey through foster care is fraught with uncertainty, instability, and far from ideal conditions. A 2011 survey reported that 13 percent of all foster children run away at least once, and another 9 percent abandon their foster homes to live with friends. Clearly, these children believe that the foster care system is not the solution to their own domestic problems at home with their biological parents. Some of these problems may arise from a mis-match between the foster families and the children they foster.

### DESCRIPTION OF THE DRAWINGS

FIG. 1 is a simplified block diagram of an exemplary embodiment of a cloud-based placement referral intelligent matching engine and web portal according to the teachings of the present disclosure;

FIG. 2 is a simplified block diagram of an exemplary embodiment of a matching engine for the cloud-based placement referral intelligent matching engine and web portal according to the teachings of the present disclosure;

FIG. 3 is a simplified block diagram of an exemplary embodiment of a foster web portal for the cloud-based placement referral intelligent matching engine and web portal according to the teachings of the present disclosure;

FIG. 4 is a simplified block diagram of an exemplary embodiment of a licensing web portal for the cloud-based placement referral intelligent matching engine and web portal according to the teachings of the present disclosure;

FIG. 5 is a simplified block diagram of an exemplary embodiment of a placement web portal for the cloud-based placement referral intelligent matching engine and web portal according to the teachings of the present disclosure; and

FIG. 6 is a simplified block diagram of an exemplary embodiment of a recruitment web portal for the cloud-based placement referral intelligent matching engine and web portal according to the teachings of the present disclosure.

### DETAILED DESCRIPTION

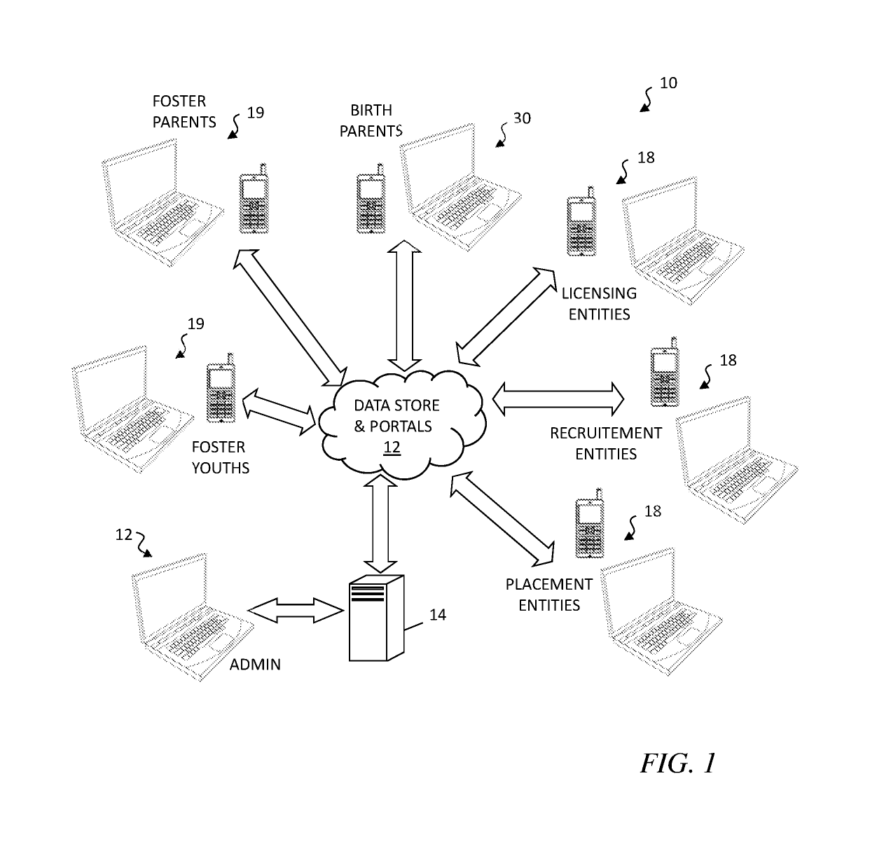

FIG. 1 is a simplified block diagram of an exemplary embodiment of a cloud-based placement referral intelligent matching engine and web portal 10 according to the teachings of the present disclosure. There is a desire to connect children in the care of a county and/or state government agency or entity with available licensed foster families that match the needs of children through the use of a customized, web-based software solution that utilizes an automated assessment, referral, and connection tool set called the Placement and Referral Intelligent Matching Engine (PRIME) and web portal 10. PRIME targets foster youth and foster family management of resources, and matches youth to families and families to youth in an intelligent manner. Through the use of system 10, all parties have access to real-time data and reporting, significantly increasing the efficiency and accountability of all parties involved in the foster care program. System 10 includes cloud-based data store and portals 12 that may be accessed in real-time via a global computer network such as the Internet. System 10 includes a web and data server 14 accessible by a system administrator 12. Further, foster youths 16, foster parents 18, birth parents 20, licensing entities 22, and placement entities 24 may access system data via customized web portals designed for each type of entity.

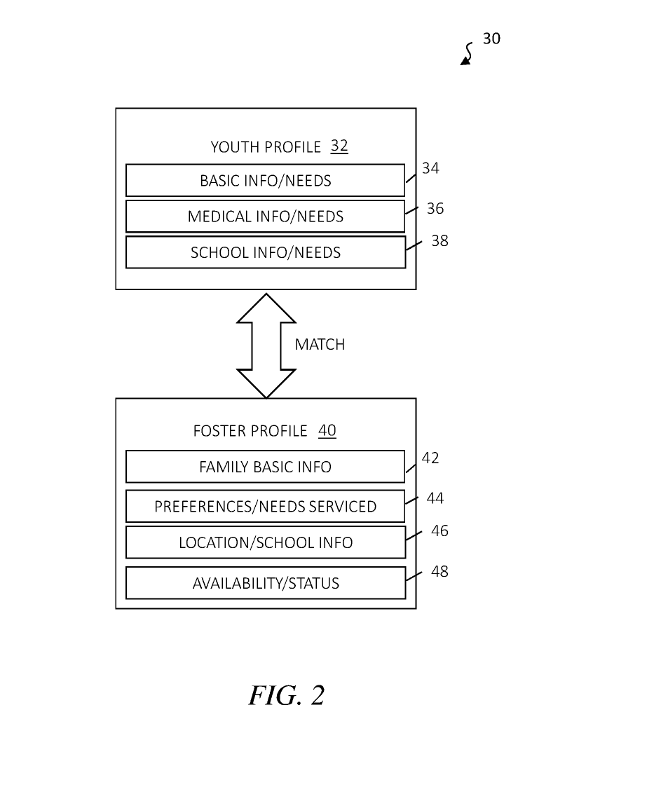

FIG. 2 is a simplified block diagram of an exemplary embodiment of a matching engine 30 for the cloud-based placement referral intelligent matching engine and web portal 10 according to the teachings of the present disclosure. Each youth entering the foster program may have a profile 32 created in the system 10 that includes the child's basic information 34, such as name, age, sex, race, recent photograph; medical history information and needs 36; and school information 38, such as school district, grade level, special needs, hobbies/interests, etc. Each foster parent/family also has a profile 40 in the system 10 that includes basic information 42, such as composition of the family unit (how many children, type and number of pets), ages and sex of existing children; the family's preferences 44 for the foster child (e.g., sex, age, special needs, medical needs); address and location information 46; and availability and status 48. The youths' and foster families' profile information can be updated on-demand to ensure the data therein are always up-to-date and current. The profile of the youth is used to identify one or more foster family matches according to a matching algorithm to ensure the best optimal fit for both parties. For example, the age of the youth in comparison to the desired age from the potential foster parent is important to meet expectations. Location is an important factor as it is critical to keep the youth close to his/her school to keep some level of normalcy and not disrupt existing relationships and ties to friends, classmates, and teachers. Medical history is also important. For example, it is unwise to assign a child with allergies to cats to a foster family that owns three cats. Further, with over 50% of foster youth having a chronic medical condition, it is important that the foster family is able to continuously monitor meds & not miss doctor appointments. Because over 60% of youths has some level of mental illness primarily arising out of their difficult home life, it is also important to match a family to a youth according to such the family's willingness or abilities to deal with such issues. Interests of the child matched to the family members' interests or vice versa is also important, as is the family size and make up and ages of other children in family. It is also vital to consider input from the foster youth on the match when possible.

The secure, hosted, web-based solution, also called Placement Referral Intelligent Matching Engine (PRIME) and web portal 10, provides separate portals for the government agency or entity (licensing, placement, and administration), Foster Parents, and Higher Level of Care Agencies. System 10 also provides placement management solution, tracking, reporting, real-time data sharing, and dashboard for the government agency/entity. System 10 provides real-time user access to data via smartphones, Tablets, PCs and other computing devices. System 10 integrates data from the government agency/entity's existing electronic case management tool, and from manual tool sets currently being used for data entry and manipulation via the web portal and mobile devices. System 10 also provides a stream-lined communication referral portal and automated reminders that provide foster parents with all information needed to properly receive and parent the foster child. System 10 provides administrative programming functions to manage clearance level permission roles of all users. System 10 provides automated tools to allow system level administrators to communicate and connect with System 10 service users working with participating clients using automated tool sets.

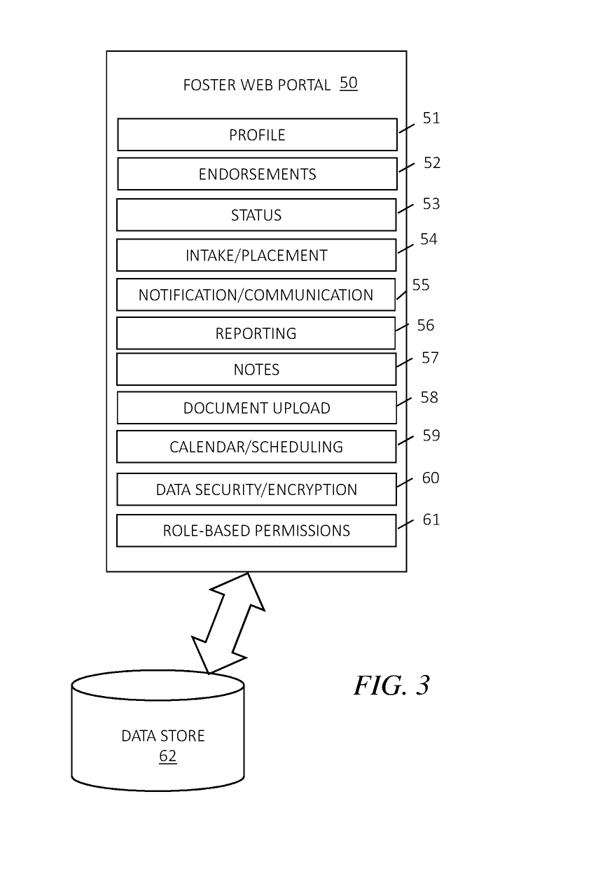

FIG. 3 is a simplified block diagram of an exemplary embodiment of a foster web portal 50 for the cloud-based placement referral intelligent matching engine and web portal 10 according to the teachings of the present disclosure. The foster web portal 50 provides foster families an interface to access, update, and send data and messages. As described above, each foster parent/family has a profile 51 that enables matching to foster youths. The foster family may also receive endorsements or rating 52 by placement and/or licensing entities. The profile may further include a status indicator 53 to let other parties know if there is a vacancy present at the foster family. The foster portal may also include an intake/placement referral tool 54. A notification and communication module 55 enables the foster family to send and receive messages and other information that may be automatically generated by the system or other parties. A reporting module 56 enables the foster family to generate, download, and print reports. A notes module 57 enables the foster family to add notes about a foster child or other data. The web portal also enables the foster family to easily upload documents, such as the report card, doctor's notes, prescription information, to the system using document upload module 58. A calendar module 59 enables the foster family to schedule appointments for the fostered youth. All data are stored in a data store 62 which is preferably cloud-based with a backup database. All data are encrypted according to the highest standards 60. Access of data stored in the cloud-based data store 62 is preferably assigned according to role-based permissions 61.

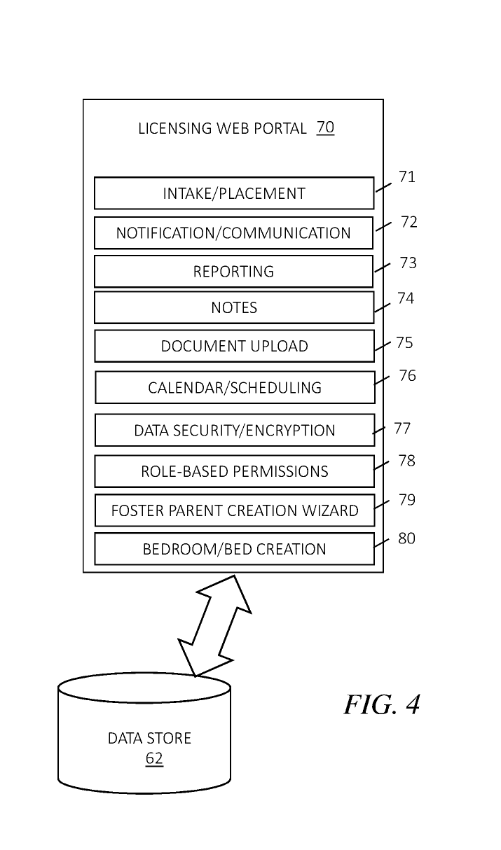

FIG. 4 is a simplified block diagram of an exemplary embodiment of a licensing web portal 70 for the cloud-based placement referral intelligent matching engine and web portal according to the teachings of the present disclosure. The licensing entity portal 70 may also include an intake/placement referral tool 71. A notification and communication module 72 enables the licensing entity to send and receive messages and other information that may be automatically generated by the system or other parties. A reporting module 73 enables the licensing entity to generate, download, and print reports. A notes module 74 enables the licensing entity to add notes about a foster child or other data. The web portal 70 also enables the licensing entity to easily upload documents to the system using document upload module 75. A calendar module 76 enables the foster family to schedule appointments for the fostered family. All data are stored in a data store 62 which is preferably cloud-based with a backup database. All data are encrypted according to the highest standards 77. Access of data stored in the cloud-based data store 62 is preferably assigned according to role-based permissions 78. The licensing entity may also create, search/access and change the status of foster families 79 while also creating the specifics of the Beds/Bedrooms within the Home itself 80.

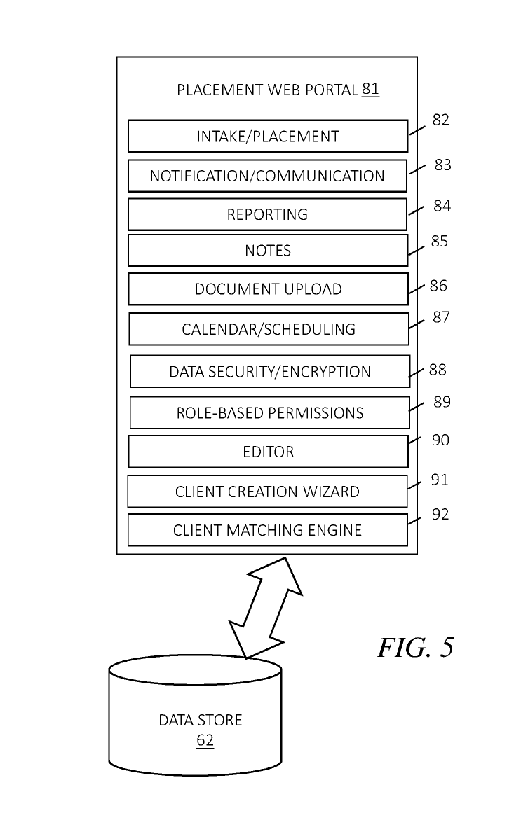

FIG. 5 is a simplified block diagram of an exemplary embodiment of a placement web portal for the cloud-based placement referral intelligent matching engine and web portal according to the teachings of the present disclosure. The placement entity web portal 81 may also include an intake/placement referral tool 82. A notification and communication module 83 enables the placement entity to send and receive messages and other information that may be automatically generated by the system or other parties. A reporting module 84 enables the placement entity to generate, download, and print reports. A notes module 85 enables the placement entity to add notes about a foster child or other data. The web portal 81 also enables the placement entity to easily upload documents to the system using document upload module 86. A calendar module 87 enables the foster family to schedule appointments for the fostered youth/family. All data are stored in a data store 62 which is preferably cloud-based with a backup database. All data are encrypted according to the highest standards 88. Access of data stored in the cloud-based data store 62 is preferably assigned according to role-based permissions 89. The placement entity may also use an editor 90 to create, edit, and update the youths' profile data. The placement entity may also create and then search youths' profiles via the web portal 91. Placement entities may also match youth to foster parents via the matching engine 92.

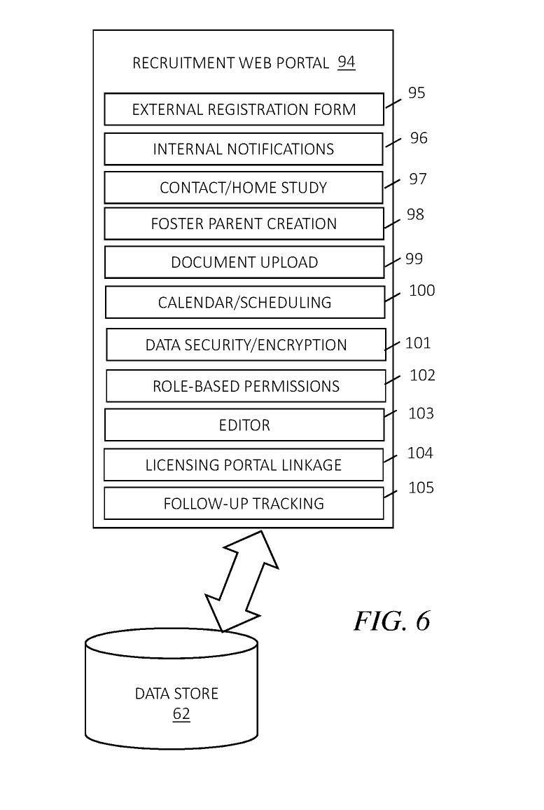

FIG. 6 is a simplified block diagram of an exemplary embodiment of a recruitment web portal 94 for the cloud-based placement referral intelligent matching engine and web portal according to the teaching of the present disclosure. The recruitment entity portal 94 may also include an external registration form 95, with an internal notification system for alerting of completion of forms 96. The recruitment entity may also track contact and home studies for their prospective foster families 97. Recruitment entities may also create foster parent profiles 98. The web portal 94 also enables the placement entity to easily upload documents to the system using document upload module 99. A calendar module 100 enables the recruitment entity to schedule appointments for the fostered family. All data are stored in a data store 62 which is preferably cloud-based with a backup database. All data are encrypted according to the highest standards 101. Access of data stored in the cloud-based data store 62 is preferably assigned according to role-based permissions 102. The recruitment entity may also use an editor 103 to create, edit, and update the youths' profile data. The recruitment entity may also link their prospective families directly to the licensing entity for final license creation 104, with full follow-up tracking in place 105.

Although not shown explicitly herein, the youths in the foster care program and the birth parents may also be given customized web portals to access data and send/receive messages related to the youths.

In summary, Placement Referral Intelligent Matching Engine (PRIME) and web portal 10 includes a software as a service (SaaS) solution that connects children, caregivers, and agencies to improve the health, safety, and well-being of children in care; enterprise level, web-based, secure and federally compliant platform that links children to the best caregiver available by matching based on exact needs in a real time environment; case Management, tracking, referral portals, real-time data sharing, assessments, surveys, calendaring, reporting, and data dashboard; a HIPPA compliant framework that adheres to federal privacy standards; a cloud-based system with 99.9% uptime that is securely hosted solution and utilizes military grade encryption for data; both in transition and while at rest; accessibility via an array of internet connected devices (pc, tablet, and smartphone) and operating systems (Windows, OS); and communication portals for the department, care givers, agencies, and youth that include the ability to coordinate services, provide surveys and assessments, manage appointments, and deliver automated reminders and alerts.

Placement Referral Intelligent Matching Engine (PRIME) and web portal 10 includes a suite of tools: Foster Parent Management (recruitment, training, licensing, and support); Intake/Placement Referral tools; Assessment tools; Case Coordination tools; Communication tools; Scheduling tools; and Reporting tools.

Placement Referral Intelligent Matching Engine (PRIME) and web portal 10 provides the following functions and capabilities: Ensure data security; Increase accessibility of information by staff and care givers; Generate ad-hoc or standardized reports on any data set or combination in their system; Create a profile of each available placement provider to include preferences, type of setting, and history; Recruit interested Foster Parents with full on-boarding capabilities; Have real time automated data collection and decision support for matching wards and providers, facilitating and streamlining the collection and exchange of ward and provider information; Create a centralized database of all providers; Provide an outward facing interface for providers to update and access their information (current vacancies, bed availability-pending, absences, preference checklist), which allows for their input while isolating their information from other providers; Create a child profile that uses unique identifiers such as behavioral characteristics, special needs, and demographics to provide a list of providers that best meet the needs of the specific child; Link siblings' cases; Allow for complete view of placement history and track stability by tracking the individual placement of each child including tracking Shelter and Emergency Foster Care populations; Have interoperability with Department's case management systems; Track and manage foster children's placements and disruptions; Have a NIST compliant Database Security Model and HIPPA compliant framework; Be scalable both vertically (inside agency) and horizontally (outside agency); Define and edit matching algorithms to standardize provider matching recommendations; Employ matching algorithms to recommend placement providers available and suited to meet a child's needs, showing results in order of best match; Provide complete child's profile, candidate provider profiles, and perform matching operations; and Define and execute workflows involving multiple parties, dependencies, deadlines, notifications (email, text) and triggers.

Foster Parent Web Portal provides for initial sign-up and portal creation: Foster Parent Sign-up Functionality through simple link sharing from the Licensing Worker with dependency factor of existing Facility Number or Licensing Number; once sign-up is completed the Foster Parent's account will be on-hold with alerts to the Licensing Worker for approval or denial.

Once approved, the foster parent portal provides: foster parents the ability to edit, update, and add data to the approved sections within their Foster Parent Profile; Foster Parents or Licensing Workers are able to build their Unique Beds (for matching) within each of their portals; allows the Foster Parents to receive and respond to new referral matches sent to their account; Foster Parents have access to a Universal Calendar for inputting days of availability for interviews, appointments and other critical meeting dates; Foster Parents are able to update their Status from Active to On-Hold with the requirement they select the date range for this status change as well as a description as to why; Foster Parents the ability to edit several sections of data on their Profile page with alerts being sent out including (edit capabilities are limited to only approved sections by Licensed Workers); An Endorsement section exists with the Foster Parent Profile page for Placement Workers, Licensing Workers and agency users to be able to document strengths and successes of Foster Parents; Foster Parents will have the ability to update their username, passwords, and notification preferences from their Profile; Foster Parents are able to fill out surveys and assessments within the system and have it sent back to their Placement and Licensing Workers.

The Licensing Worker Portal provides for initial Sign-Up and Portal Creation, and Licensing Workers have a unique portal with proper roles and permissions assigned. Licensing Workers will have the ability to add sub-orgs for their portal which will consist of outside agencies, agencies foster parents and DFS Foster Parents. Licensing Workers have the ability to change passwords, email login, notification preferences and more from their portal. Licensing Workers may access a Notification Panel for alerts, changes, and updates to any of their foster parents, agencies, beds, and other critical data; an Internal Messaging Center in order to send messages to other users within the system including agencies, foster parents and Placement Workers; and youth profiles within their Sub-Organization agencies and foster parents for viewing History of Placement and Outcomes. Licensing Workers have the ability to change the status of a Foster Parent to “On Hold.”

Placement Worker Web Portal provides for Initial Sign-Up and Portal Creation. Placement Workers have a unique portal with proper roles and permissions assigned. Placement Workers have the ability within their portal or their Sub-Orgs to change passwords, email login, notification preferences and more from their portal.

Placement Workers have access to a Notification Panel for alerts, changes, and updates to any of their Youth or Partnering Foster Parents, Agencies, Beds, and other critical data. Placement Workers have access to an Internal Messaging Center in order to send messages to other users within the system including Youth (when feature is utilized), Agencies, Foster Parents and Licensing Workers. Placement Workers have the ability to create, edit, watch, and update a Youth Profile page. Placement Workers have the ability to view a full list of youth within their portal as well as filter to youth assigned just to their personal account. Placement Workers are able to access the Referral Matching section of the system for connecting a youth to a potential Foster Parent. Placement Workers have the ability to upload images and documents for the youth. Placement Workers have the ability to complete a Care Giver Survey at the completion of a placement.

There are some universal features that are common across all portal types: reporting, messaging, and notes. Placement Workers, Licensing Workers as well as Administration have the ability to pull customized reports. These reports are available on any level of data: youth level, youth case level, foster parent level, agency level and even specific field level reporting. All users have access to a Management section for their account to be able to change notification preferences, update information and more.

Messaging exists in 3 formats: General Messaging, Client Level Messaging, and Case Level Messaging. Placement and Licensing Workers have access to a Centralized Messaging Center which will allows them to send and receive general messages from single users, agencies, foster parents, youth and others through their main portal. Placement Workers, Licensing Workers, and Foster Parents have access to a client specific section allowing for communication to take place on a single client with the history of the messages tracked (this exists in more of a chat flow, however it will not be a real-time chat). Placement Workers, Licensing Workers, and Foster Parents also have access to a case specific section allowing for communication to take place on a single case with the history of the messages tracked (this exists in more of a chat flow, however it will not be a real-time chat).

System 10 provides users the ability to add Notes. There is a Notes section for users to add anything pertaining to the Youths. This will be only viewable by a Placement Worker or Licensing Worker, however it can be unlocked to Foster Parents or the youth themselves, if desired. Further, Notes can be added on a specific Placement with the notes section only seen and responded to by a Placement Worker or a Licensing Worker. A notes section is also provided within the Profile of a Foster Parent. This notes section can only be seen by a Placement Worker or a Licensing Worker so they can add Notes on a specific family for internal review purposes.

Placement Workers and Licensing Workers also have the ability to upload documents at the youth Level, youth's case level, foster parent level and other desired locations. These documents can then be viewable by the Foster Parents, youth, other Licensing Workers and Placement Workers (as selected for the uploaded document).

The features of the present invention which are believed to be novel are set forth below with particularity in the appended claims. However, modifications, variations, and changes to the exemplary embodiments described above will be apparent to those skilled in the art, and the Placement Referral Intelligent Matching Engine (PRIME) and web portal 10 described herein thus encompasses such modifications, variations, and changes and are not limited to the specific embodiments described herein.

What is claimed is:

1. A computer-implemented system comprising:
a cloud-based encrypted database;
a web portal for a placement entity configured to enable creation of a profile containing real-time data for each youth in a foster care program, including age, sex, race, school location, medical history, special needs, hobbies, and interests, and storing the youth profile data and role-based data access permissions in the encrypted database;
a web portal for a recruitment entity configured to enable notification of new prospective foster families desiring to become fully licensed families, creation of these new foster families based on home studies and uploaded documentation, and linkage to licensing entities to complete the license process for the new foster families, and storing the foster family profile data and role-based data access permissions in the encrypted database;
a web portal for a licensing entity configured to enable creation of a profile containing real-time data for each foster family, including family members' composition, race, sex, and desired age for a foster child, location of home, school assignment, pets, willingness to deal with medical and/or mental illness issues, and status, and storing the foster family profile data and role-based data access permissions in the encrypted database;
a matching engine configured to access the cloud-based encrypted database to search the youth and foster family profiles, the matching engine further configured to identify best matches between foster families and youths, and generating a referral match; and
a web portal for each foster family configured to enable updating of foster family profile data, receiving new referral matches, and communicating with the licensing entity via messages.

2. The computer-implemented system of claim 1, further comprising a calendar module accessible by the foster family via the foster family web portal, by the licensing entity via the licensing we portal, and by the placement entity via the placement web portal.

3. The computer-implemented system of claim 1, further comprising an endorsement module accessible by the foster family via the foster family web portal, by the licensing entity via the licensing we portal, and by the placement entity via the placement web portal.

4. The computer-implemented system of claim 1, further comprising a notes module accessible by the foster family via the foster family web portal, by the licensing entity via the licensing we portal, and by the placement entity via the placement web portal.

5. The computer-implemented system of claim 1, further comprising a document upload module accessible by the foster family via the foster family web portal, by the licensing entity via the licensing we portal, and by the placement entity via the placement web portal.

6. The computer-implemented system of claim 1, further comprising a reporting module accessible by the foster family via the foster family web portal, by the licensing entity via the licensing we portal, and by the placement entity via the placement web portal.

7. The computer-implemented system of claim 1, further comprising a notification module displaying notification messages accessible by the foster family via the foster family web portal, by the licensing entity via the licensing we portal, and by the placement entity via the placement web portal.

8. A computer-implemented method including executing instructions stored on a computer-readable medium, the method comprising:
receiving, from a referring entity, real-time profile information about a foster family, including data about family members' composition, race, sex, and desired age for a foster child, location of home, school assignment, pets, and willingness to deal with medical and/or mental illness issues, and storing the foster family profile information in a secure database;
searching and identifying, in real-time, in response to the received foster family profile information, at least one foster child in a foster system database having characteristics including age, sex, school location, medical history, hobbies, and interests best matched for the foster family; and
electronically transmitting, in real-time, information about the identified at least one foster child to the referring entity.

9. The method of claim 8, further comprising:
providing a web portal interface to the referring agency personnel to input information and access to real-time information including foster child cases; and
providing a web portal interface to the foster family to input information and access to real-time information including information about a foster youth placed with the foster family, and calendar for appointments associated with the foster child.

10. The method of claim 9, further comprising providing a web portal interface to a placement agency personnel to update information about the foster child and provide access to real-time information about the foster child.

11. The method of claim 10, further comprising displaying notification to at least one of the foster family, referring agency personnel, and placement agency personnel via at least one of the web portals.

12. The method of claim 10, further comprising transmitting messages to at least one of the foster family, referring agency personnel, and placement agency personnel via at least one of the web portals.

13. The method of claim 10, further comprising receiving and storing notes related to at least one of the foster family and foster child via at least one of the web portals.

14. The method of claim 10, further comprising receiving and storing endorsements relating to a foster family via at least one of the web portals.

15. The method of claim 10, further comprising scheduling appointments for least one of the foster family and foster child via at least one of the web portals.

16. A computer-readable medium having encoded thereon a computer-implemented method comprising:
receiving, from a referring entity, real-time profile information about a foster child in a foster system database having characteristics including age, sex, school location, medical history, hobbies, interests, and storing the foster child profile information in a secure database;
searching and identifying, in real-time, in response to the received foster child profile information, at least one foster family, including data about family members' composition, age, and sex, desired age for a foster child, location of home, schools, pets, willingness to deal with medical and/or mental illness issues best matched for the foster child; and
electronically transmitting, in real-time, information about the identified at least one best matched foster family to the referring entity.
